(19) United States
(12) Patent Application Publication
(10) Pub. No.: US 2016/0217518 A1
(43) Pub. Date: Jul. 28, 2016

(54) Custom Sexual Stimulation Device Production System And Method

(71) Applicant: Joseph M. Shapiro, Union, NJ (US)

(72) Inventor: Joseph M. Shapiro, Union, NJ (US)

(21) Appl. No.: 15/007,103

(22) Filed: Jan. 26, 2016

Related U.S. Application Data
(60) Provisional application No. 62/108,444, filed on Jan. 27, 2015.

(51) Int. Cl. G06Q 30/06; A61H 19/00; G05B 19/4099; G06Q 10/08; B29C 67/00

(52) U.S. Cl. CPC G06Q 30/0621; G06Q 30/0635; G06Q 10/083; B29C 67/0088; G05B 19/4099; A61H 19/40; G05B 2219/35134; G05B 2219/49007; B33Y 50/02

(57) ABSTRACT

Exemplary embodiments are directed to a computer-implemented system, method, and non-transitory computer-readable storage medium for custom sexual stimulation device production, including receiving 3D scan information from a plurality of remote users, providing 3D scan information to a database, transmitting 3D scan information to each of a plurality of networks, verifying the 3D scan information against at least one network database, initiating the production of a custom sexual stimulation device utilizing the 3D scan information, and delivering a custom sexual stimulation device to at least one of the plurality of remote users. The 3D scan information received from the plurality of remote users is generally comprised of 3D scan data, production data, delivery data, security data, user data, and verification data. The 3D scan information generally corresponds to at least one remote scan subject, at least one remote device consumer, or a combination thereof. The method further includes verifying the 3D scan information against the plurality of networks of the system. The present disclosure is further directed to a system for producing custom sexual stimulation devices utilizing 3D scan information received from a plurality of remote users, including a computer storage device to store 3D scan information and a processing device to initiate, through the plurality of networks via a communications network, at least one of a receiving 3D scan information operation, a providing 3D scan information to a database operation, a verifying 3D information operation, a transmitting 3D scan information operation, a transforming 3D scan information operation, an initiating production based upon the 3D scan information operation, a delivering a custom sexual stimulation device operation, and a providing real-time feedback operation.

### TECHNICAL FIELD

The present disclosure relates to methods and systems of producing custom sexual stimulation devices and, more particularly, production of custom sexual stimulation devices utilizing 3D scan information received from each of a plurality remote users, wherein the resulting devices are privately and securely produced with improved authentic and associative characteristics.

### BACKGROUND

Many sexual stimulation devices, i.e., dildos, vibrators,and personal massagers, are widely available to consumers. Most sexual stimulation devices presently available to consumers are designed as abstract shapes or as rudimentary representations of a human body. Alternatively, many sexual stimulation devices presently available to consumers are modeled upon the bodies of unknown individuals, or upon the bodies of “celebrity” individuals. Further, most sexual stimulation devices currently available to consumers limit customization options to manipulation of abstract and/or rudimentary shapes. Most sexual stimulation devices, therefore, lack any true custom, authentic, or associative characteristics relevant to any particular consumer.

3D scanning, 3D modeling, and 3D printing technologies are presently available to consumers. 3D scanning, 3D modeling, and 3D printing technologies allow consumers to accurately scan and reproduce real world 3D forms in a range of mediums such as plastics, metals, ceramics, and the like. However, the current process of 3D scanning, 3D modeling, and 3D printing requires monetary investment and technical sophistication in 3D technology such as 3D computer aided design (CAD) and 3D computer aided manufacturing (CAM). Despite mainstream recognition these technologies, 3D scanning, 3D modeling, and 3D printing has not yet become commonplace for most consumers. Further, production of custom sexual stimulation devices using 3D printing technology requires heightened safety considerations, such as the toxicity, cleanliness, and durability of 3D printed material. Additionally, as sexual stimulation devices are generally purchased in a discrete manner, production of such devices requires heightened consumer security and privacy considerations and restrictions.

Therefore, there is a need for an improved system and method of discretely producing custom sexual stimulation devices. The present invention is directed to overcoming, or at least reducing the effects of, one or more of the problems set forth above.

### SUMMARY

In one embodiment, the present disclosure provides a method of producing custom sexual stimulation devices and, in particular, a method for producing custom sexual stimulation devices utilizing 3D scan information received from each of a plurality of remote users. The method generally includes receiving 3D scan information, e.g., 3D scan data, production data, delivery data, security data, and user data, from remote users, providing that 3D scan information to a database, and initiating the production of at least one custom sexual stimulation device. The method further includes verification of the 3D scan information against a network database, e.g., a 3D scan database, a production database, a delivery database, a security database, a combination thereof, and the like. The exemplary method further generally includes transmitting 3D scan information to a plurality of networks via a communications network and delivering a custom sexual stimulation device to at least one of a plurality of remote users. 3D scan information corresponds to at least one remote scan subject, to at least one remote device consumer, or to a combination thereof, and the like. Generally, the method includes transferring the 3D scan information through a secure network and reporting verification information, e.g., verification data, 3D scan data, production data, delivery data, and/or security data from the plurality of networks to at least one remote scan subject, to at least one remote device consumer, to a combination of both, and the like. The method further includes access restrictions at each particular step of the system to ensure the security and privacy of the 3D scan information provided to and received from each of a plurality of remote users through the system. Thus, the disclosed method provides users an efficient, secure, and private process of producing custom sexual stimulation devices.

In general, the remote collection of 3D scan information of the disclosed method can be, e.g., collection of 3D scan information via delivery of 3D input devices between remote users and a 3D input device distributor via a physical delivery method, reception of 3D scan information directly from remote users over a network via 3D input devices, reception of 3D scan information indirectly from remote data repositories over a network, a combination thereof, and the like. The 3D scan information collection can be performed via a 3D data network and can be an automated process. The 3D scan information can also be transmitted to each of a plurality of networks, e.g., a 3D data network, a production network, a delivery network, a security network, and the like, in a standardized and/or normalized for, thereby providing desired 3D scan information to each of a plurality of networks in forms and/or formats which are easily accessible and/or understood. The disclosed method can further include transforming unprocessed 3D scan data into processed 3D scan data, transforming processed 3D scan data into 3D model data, and transforming 3D model data into a production data, and transforming production data into a custom sexual stimulation device.

In accordance with an exemplary embodiment of the present disclosure, a computer-implemented system is disclosed for producing custom sexual stimulation devices and, in particular, a system for producing custom sexual stimulation devices utilizing 3D scan information remotely collected from users is disclosed. In particular, the system includes a computer storage device and a processing device. The computer storage device generally stores 3D scan information. The processing device generally collects 3D scan information from at least one user, transmits 3D scan information to a plurality of networks via a communications network, initiates production of at least one custom sexual stimulation device, and delivers a custom sexual stimulation device to at least one user.

In accordance with an exemplary embodiment of the present disclosure, a non-transitory computer readable medium storing instructions is disclosed, wherein execution of the instructions by a processing device causes the processing device to implement a method. In particular, the method generally includes collecting 3D scan information, transmitting 3D scan information to a database, transforming 3D scan data from unprocessed to processed 3D scan data, transforming processed 3D scan data into 3D model data, initiating production of at least one custom sexual stimulation device, and delivering a custom sexual stimulation device to at least one user. In general, the method further includes transmitting 3D scan information to a plurality of networks via a communications network and delivering a custom sexual stimulation device to a consumer via a delivery network.

Therefore, the disclosed systems and methods provide a secure, private, automated/semi-automated, simplified and improved process of producing custom sexual stimulation devices. Specifically, the disclosed systems and methods provide an efficient and automated transformation of unprocessed, remotely collected 3D scan information into a custom sexual stimulation device, secure delivery of the custom sexual stimulation device, and an interface for verifying, managing, and tracking the processing, production, and delivery of the custom sexual stimulation device.

Other objects and features will become apparent from the following detailed description considered in conjunction with the accompanying drawings. It is to be understood, however, that the drawings are designed as an illustration only and not as a definition of the limits of the invention.

### BRIEF DESCRIPTIONS OF THE DRAWINGS

To assist those of skill in the art of making and using the disclosed systems and methods, reference is made to the accompanying figures, wherein:

FIG. 1 is an exemplary custom sexual stimulation device production system computer-implemented in accordance with the present disclosure;

FIG. 2 is a block diagram of an exemplary computing device configured to implement embodiments of the custom sexual stimulation device production system;

FIG. 3 is a block diagram of an exemplary computing system for implementing embodiments of the custom sexual stimulation device production system;

FIG. 4 is an alternative flowchart illustrating an exemplary computer-implemented process performed using embodiments of the custom sexual stimulation device production system; and

FIG. 5 is an alternative flowchart illustrating an exemplary computer-implemented process performed using embodiments of the custom sexual stimulation device production system; and

FIG. 6 is a flowchart illustrating an exemplary computer-implemented process performed using embodiments of the custom sexual stimulation device production distribution system.

### DESCRIPTION OF EXEMPLARY EMBODIMENTS

Exemplary embodiments of the present disclosure are directed to a computer-implemented method of producing custom sexual stimulation devices and, in particular, a method of producing custom sexual stimulation devices utilizing 3D scan information received from remote users. Custom sexual stimulation devices may include, but are not limited to, dildos, vibrators, personal massagers, and the like, and may be produced using various production techniques, e.g., 3D printing, casting, molding, and the like. However, it should be understood that the production technique(s) implemented can vary based on what customizations are deemed acceptable to a given user. The method generally includes receiving 3D scan information from at least one remote user, providing 3D scan information to a database, and initiating at least one custom sexual stimulation device production. The exemplary method further generally includes transmitting 3D scan information to a plurality of networks via a communications network and delivering at a custom sexual stimulation device to a remote user via a delivery network. The 3D scan information corresponds to at least one remote scan subject, to at least one remote device consumer, or to a combination thereof The method further includes verifying the 3D scan information against a database, e.g., a 3D scan database, a production database, a delivery database, a security database, a combination thereof, and the like. Generally, the method includes transferring the 3D scan information through a secure network and reporting data, e.g., 3D scan data, user data, production data, verification data, security data, and/or delivery data, from the plurality of networks to at least one remote user. Thus, the disclosed method provides an efficient, secure, and private process of producing custom sexual stimulation devices utilizing 3D scan information received from at least one remote user.

In particular, exemplary embodiments of the disclosed computer-implemented methods provide a single point and/or channel for remote 3D scan information reception, 3D scan information transmission, custom sexual stimulation device production, and custom sexual stimulation device delivery, thereby allowing remote users to, e.g., securely and privately transfer 3D scan information, transform 3D scan information into a custom sexual stimulation device, deliver the custom sexual stimulation device to at least one remote user, manage and track the production and delivery of the custom sexual stimulation device, and the like. The exemplary methods further automate one or more of these processes and provide a single-point user interface, i.e., a graphical user interface, rather than requiring multiple interfaces for remote users to access, perform, manage and organize the tasks separately on different systems. The disclosed systems and methods also allow users to utilize a single system to manage the security and privacy of their 3D scan information, the production of custom sexual stimulation devices, and of the delivery of custom sexual stimulation devices.

In general, each remote user can have different custom sexual stimulation device customization requirements, e.g., materials, finishes, functionalities, and the like. Therefore, the disclosed systems and methods provide sufficient production information in a standardized and/or normalized form so as to permit a custom sexual stimulation device manufacturer and other entities involved in the production of the custom sexual stimulation devices to conveniently obtain the desired and/or required production and delivery information from a single source. In particular, the exemplary systems standardize and/or normalize the custom sexual stimulation device production process for users. For example, the exemplary systems can consolidate the plurality of information collection and transmission, custom sexual stimulation device production and custom sexual stimulation device delivery, and custom sexual stimulation device management systems and methods into a single point reference and interface. Thus, a user can interact with the custom sexual stimulation device production system via a single-point interface to remotely create, transmit, and transform 3D scan information into a custom sexual stimulation device. The custom sexual stimulation device production process can be further normalized such that custom sexual stimulation devices are delivered in a standardized manner and in accordance with the requirements of each one of the plurality of users. The disclosed systems thereby receive 3D scan information from remote users, automate the process of transmitting 3D scan information to the network entities involved in production of custom sexual stimulation devices, transform 3D scan information into processed 3D scan data, transform processed 3D scan data into 3D model data, and 3D model data into production data, and transforming production data into custom sexual stimulation devices, and finally deliver and track the delivery of custom sexual stimulation devices to users. Thus, for example, the specific data and/or production requirements and/or delivery methods are programmed in and/or stored in databases such that users are not required to have intimate knowledge of the data, production and/or delivery requirements involved in production of a custom sexual stimulation device.

In further embodiments of the present disclosure, the system can deliver a 3D input device between remote users and a 3D input device distributor via a physical delivery method in order to obtain the required 3D scan information. Such an exemplary 3D scan module can allow a remote user to collect and transmit 3D scan information for use by the system in the production of a custom sexual stimulation device if that user is without the means and/or technical sophistication necessary to access a 3D input device, to transform unprocessed 3D scan data into 3D model data, and the like.

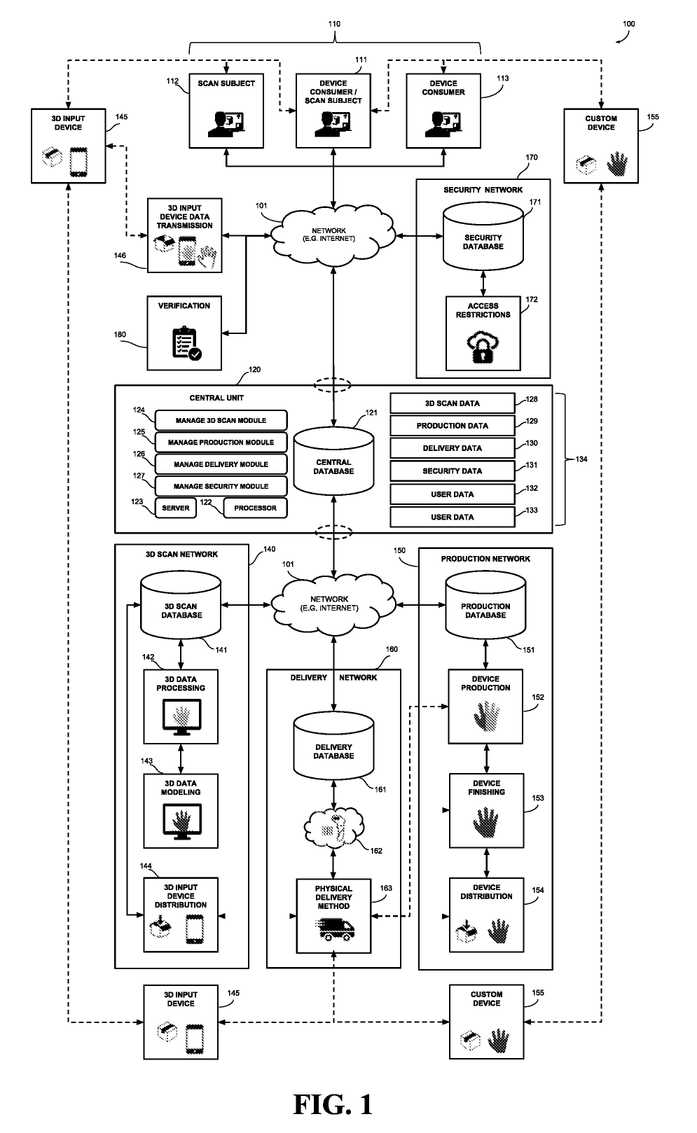

With reference to FIG. 1, an exemplary custom sexual stimulation device production system 100 is illustrated, including the network 101, the user 110, the central unit 120, the 3D scan network 140, the production network 150, the delivery network 160, the security network 170, and the verification 180. In particular, the network 101, e.g., the Internet, creates a communication media and/or network connecting the user 110, the central unit 120, 3D scan network 140, production network 150, the delivery network 160, the security network 170, and the verification 180. The network 101 thereby allows said elements of the system 100 to transfer data 134, e.g., 3D scan data 128, production data 129, delivery data 130, security data 131, user data 132, and the like, between the plurality of elements of system 100. Although illustrated as separate networks or units (e.g., separate vendors), in some exemplary embodiments, it should be understood that the system 100 may combine two or more networks into a single network or unit. As a further example, in some embodiments, the 3D scan network 140 and the production network 150 may be combined into a single network. As yet a further example, in some embodiments, the 3D scan network 140, the production network 150, and the delivery network 160 may be combined into a single network. As yet a further example, in some embodiments, the 3D scan network 140, the production network 150, the delivery network 160, and the security network 170 may be combined into a single network. As yet a further example, in some embodiments, the central unit 120, the 3D scan network 140, the production network 150, the delivery network 160, and the security network 170 may be combined into a single network. As yet a further example, in some embodiments, the central unit 120 and the 3D network 140 may be combined into a single network. As yet a further example, in some embodiments, the central unit 120, the 3D network 140, and the production network 150 may be combined into a single network. As yet a further example, in some embodiments, the central unit 120, the 3D network 140, the production network 150, and the delivery network 160 may be combined into a single network. As yet a further example, in some embodiments, the central unit 120, the 3D network 140, the production network 150, the delivery network 160, and the security network 170 may be combined into a single network. The user 110 can be, e.g., the device consumer/scan subject 111, the scan subject 112, the device consumer 113, and the like, and can be connected to the network 101 through, for example, a computer, a smartphone, a tablet, and the like.

The central unit 120, e.g., the central computing device, includes the central database 121, which stores data 134 specific to a plurality of consumer/scan subjects 111, scan subjects 112, and consumers 113 entered by the user 110. For example, the central database 121 can store user 110 3D scan information necessary for implementation of the system 100, such as, e.g., 3D scan data 128 (e.g., point cloud data, color output data), production data 129 (e.g., materials, colors, finishes), delivery data 130 (e.g., shipping address, tracking information), security data 131 (e.g., privacy restrictions, security verifications), user data (e.g., email address, phone number) and the like. The central database 121 can further store the specific 3D scan information necessary for, and required by, the networks and elements of the system 100 necessary for the production of custom sexual stimulation devices. The 3D scan information stored in the central database 121 specific to the plurality of users 110 can be entered into the central database 121 by a user 110 over the network 101 through, for example, a graphical user interface. Thus, the data 134 stored in a standardized and/or normalized form in the central database 121 can then be distributed accordingly through the secure network 101 to the relevant entities and/or networks requiring the data 134 for implementation of the system 100.

In a further embodiment of the system 100, a verification 180 can occur in the process of a user 110 entering 3D scan information, e.g., 3D scan data 128, production data 129, delivery data 130, security data 131, user data 132, and/or the like, into the graphical user interface and/or network and/or after that data 134 is received in the central database 121. The verification 180 can include verifying the 3D scan information against a database, e.g., a 3D scan database 141, a production database 151, a security database 171, a delivery database 161, a combination thereof, and the like. Specifically, the verification 170 confirms that the 3D scan information entered into the central database 121 by the user 100 is correct and/or is sufficient for the production and delivery of a custom device 155. The verification 180 depicted in FIG. 1 is connected to the network 101 and thereby provides feedback to a plurality of user 110 with respect to the plurality of steps implemented by the system 100 and the actions taken by the plurality of networks of the system 100. For example, the verification 180 can be, e.g., an email, an alert, and the like, and can notify a plurality of users 110 whether the data 134 entered into the central database 121 has been verified or not. Thus, the 3D scan information distributed throughout the network 101 is confirmed to be correct and accurate information with respect to a plurality of users 110.

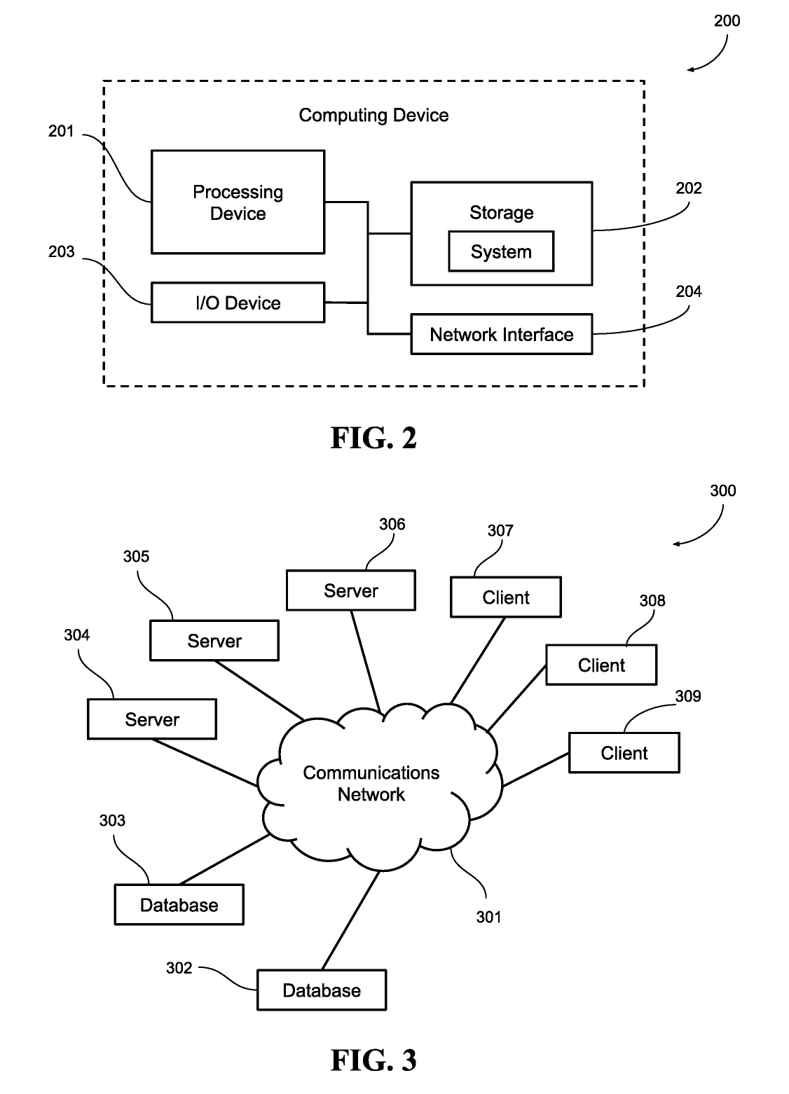

Still with reference to FIG. 1, the central unit 120 can further include the manage 3D scan module 124, the manage production module 125, the manage delivery module 126, the manage security module 127, and the like. The manage 3D scan module 124 can organize, manage and distribute the applicable 3D scan data 128, e.g., unprocessed 3D scan data, processed 3D scan data, 3D model data, and the like, specific to the plurality of users 110. The manage production data module 125 can organize, manage and/or distribute the custom device 155 production data 129, e.g., manufacturing specification, material restrictions, and the like, stored in the central database 121 which is specific to a plurality of users 110, including the sexual stimulation device customizations required by each user 110. The manage delivery module 126 can organize, manage and/or distribute delivery data 130, e.g., the user 110 delivery address, 3D input device distribution 144 return shipping address, and the like. The manage security module 127 can organize, manage and/or distribute the security data 131, e.g., privacy settings, security restrictions, and the like, as specified by a plurality of users 110. The processor(s) 122 and the server(s) 123 of the central unit 120, which are discussed in greater detail below with respect to FIGS. 2 and 3, are implemented in the system 100 to process and distribute data 134 necessary for permitting a plurality of users 110 to produce and deliver a custom sexual stimulation device through the manage 3D scan module 124, the manage production module 125, the manage delivery module 126, the manage security module 127, and the like.

The 3D scan network 140 is connected to the central database 121 by the network 101 and can include, e.g., the 3D scan database 141, 3D scan data processing 142, 3D scan data modeling 143, 3D input device distributor 144, which distributes 3D input devices 145 through the delivery network 160, and the like. Utilizing the network 101 and the standardized and/or normalized user 110 information collected in the central database 121, the 3D scan database 141 can collect applicable 3D scan information for use with the other elements of the 3D scan network 140. For example, the 3D scan database 141 can collect 3D scan data 128, e.g., unprocessed 3D scan data, processed 3D scan data, and the like, for distribution among the 3D scan network 140 elements. Using the information stored in the 3D scan database 141, the 3D scan network 140 can automatically transform the 3D scan data 128 using 3D scan processing 142 to ensure that the 3D scan data 128 is transformed into an acceptable format for custom sexual stimulation device production, e.g., checked for accuracy and integrity based on the information in the 3D scan database 141, processed, transformed and cleared to proceed to the next step of the 3D scan network 140. Further, the 3D scan network 140 can automatically model the 3D scan data 128 using 3D scan data modeling 143 to transform 3D scan data 128 into a form acceptable to the elements and networks of the system 100, e.g., manipulated, modified, resculpted, reformatted, and the like, and within the form and format acceptable to the production network 160. The 3D scan database 141 can remotely collect 3D scan data 128 from users 110 directly or indirectly over the network 101 and/or via a physical delivery method 163, e.g., remote collection of 3D scan data 128 stored on 3D input devices 145 delivered between plurality of remote users 110 and a 3D input device distributor 144, via physical delivery method 162, remote collection of 3D scan data 128 stored on and transmitted by 3D input devices 145 via 3D input device data transmission 146, direct electronic transmission of 3D scan data 128 from users 110 over the network 101, via indirect remote collection of 3D scan data 128 from a plurality of users 110 via the network 101 from a data repository (not shown), a combination thereof, and the like.

With reference now to the production network 150 of FIG. 1, the production database 151 can receive over the network 101 the 3D scan information applicable to the production network 150, e.g., materials, colors, finishing, detailing, and the like. The production database 151 can then implement the data 134 required to transform the production data 129 into a custom sexual stimulation device, i.e., customized by the plurality of users 110. For example, the custom device 155 can be a sexual stimulation device, e.g., a vibrator 3D printed by device production 152 and fitted with electronic components by device finishing 153, utilizing 3D scan data 128 provided by an individual scan subject 112, but utilizing production data 129, e.g., materials, colors, finishes, and the like, remotely collected from a separate individual device consumer 113.

The delivery database 161 of the delivery network 160 receives over the network 101 the data 134 applicable to the delivery network 160, e.g., the shipping address of a user 110, the shipping address of the 3D input device distributor 144, and the like. The delivery network 160, e.g., the U.S. Postal Service, can further include delivery tracking methods 162, e.g., barcode scanning, certified mail, and the like, and a physical delivery method 163 by which a custom device 155 can be delivered to a user 110. The physical delivery method 163 of the delivery network 160 can further be used to deliver a 3D input device 145 by and between the 3D input device distributor 144 and a remote user 110 for use in collecting and storing the required data 134, e.g., 3D scan data 128, production data 129, delivery data 130, security data 131, user data 132, and the like, for transmission to the database 121. Further, the physical delivery method 163 of the delivery network 160 can be used to deliver a custom device 155 between elements of the production network 150, e.g., device production 152, device finishing 153, device distribution 154, and the like. Although discussed herein as collecting data 134 for transmission to the database 121 from the 3D input device by and through the 3D scanning device distributor 154, in some exemplary embodiments, the 3D input device 145 may transmit the data 134 directly to the database 121 over the network 101 via a 3D input device transmission 146. Further, in some exemplary embodiments, the data 134 may be transmitted directly from the user 110 over the network 101 through, for example, a graphical user interface, obviating the need for delivery of a 3D input device 145 to that remote user 110.

Still with reference to FIG. 1, as previously disclosed herein, the verification 180 can occur prior to, during, and/or after each particular step taken by the system 100. As depicted in FIG. 1, the verification 180 can originate from the central unit 120, which remotely collects the applicable 3D scan information from all associated networks for each user 110 participating in the system 100, and then distributes the 3D scan information to each user 110 in order to provide a tracking system of production and delivery of the custom device 155. The tracking system, i.e., verification 180, can provide 3D scan information via, e.g., a graphical user interface, an email, postal service, and the like, thereby providing information easily accessible, current, and understandable to each user 110. However, it should be understood to those of ordinary skill in the art that the verification 180 can originate at, e.g., the central unit 120, each participating network of the system 100, a combination of said locations, and the like. In particular, the verification 180 can obtain tracking data from, e.g., the delivery network 160 when a 3D input device 145 has been shipped for delivery to a user 110, the 3D scan network 140 when 3D scan data 128 has been transformed into 3D model data, the production network 150 when production data 129 has been transformed into a custom device 155 acceptable to the user 110, the delivery network 160 when it has shipped the custom sexual stimulation device 155 to the user 110 via a physical delivery method 163 using delivery data 130, and the like. Thus, the user 110 is provided with a method of tracking the user's 110 custom device 155 throughout the system 100.

As further depicted in FIG. 1, access restrictions 172 can occur before, during, and/or after each particular step taken by the system 100. Access restrictions 172 can originate from the central unit 120, which remotely collects the applicable 3D scan information from all associated networks for each user 110 participating in the system 100, and then distributes the information to each user 110 in order to provide a system of security and privacy in connection with the production of the custom device 155. The security and privacy system, i.e., access restrictions 172, can collect and provide security data 131, e.g., passwords, identity verification, and the like via, e.g., a graphical user interface, an email, postal service, and the like, in connection with the plurality of user's 110 access the system 100. However, it should be understood to those of ordinary skill in the art that access restrictions 172 can originate at, e.g., the central unit 120, each participating network of the system 100, a combination of said locations, and the like. In particular, the access restrictions 172 can obtain security data 131 from, e.g., user 110 prior to the 3D scan network's 140 remote collection of 3D scan data 128 from a user 110, a user 110 prior the production network 150's transformation of 3D scan data 128 into a custom device 155 using a user's 110 3D scan data 128, from a user 110 prior to the delivery network 160 shipping a custom device 155 to a user 110 via a physical delivery method 163 using delivery data 130, and the like. Thus, each user 110 is provided with a method of ensuring the security and privacy of their data 134 and device 155 throughout the system 100. Optionally, access restrictions 172 can occur in conjunction with and/or simultaneously with a verification 180 before, during, and/or after each particular step taken by the system 100.

FIG. 2 is a block diagram of an exemplary computing device 200, e.g., the central unit 120, configured to implement some embodiments of the system 100. The computing device 200 can be a mainframe, personal computer (PC), laptop computer, workstation, server, handheld device, such as a tablet, a smartphone, portable digital assistant (PDA), and the like. In the illustrated embodiment, the computing device 200 includes a processing device 201, such as a central processing unit, and can include storage 202. The computing device 200 can further include input/output devices 203, such as a display device, keyboard, touch screen, mouse, printer, and the like, and can include a network interface 204 to facilitate communication between the computing device 200 and other devices communicative coupled to a network.

The storage 202 stores data and instructions and can be implemented using non-transitory computer readable medium technologies, such as a floppy drive, hard drive, tape drive, solid state storage devices, Flash drive, optical drive, read only memory (ROM), random access memory (RAM), and the like. For example, the storage 202 can store, e.g., 3D scan information, production information, delivery information, security information, user information, and the like. Applications, such as an embodiment of the system 100, or portions thereof, can be resident in the storage 202 and can include instructions for implementing the applications. The storage 202 can be local or remote to the computing device 200. The processing device 201 operates to execute the applications in storage 202, such as the system 100, by executing instructions therein and storing data resulting from the executed instructions, which can be presented via, for example, a graphical user interface (GUI).

FIG. 3 is a block diagram of an exemplary computing system 300 configured to implement one or more embodiments of the system 100. The computing system 300 includes servers 304-306 operatively coupled to clients 307-309, e.g., device consumer/scan subjects 111, scan subjects 112, device consumers 113, and the like, via a communication network 301, which can be any network over which information can be transmitted between devices communicatively coupled to the network. For example, the communication network 301 can be the Internet, Intranet, virtual private network (VPN), wide area network (WAN), local area network (LAN), and the like. The computing system 300 can include repositories or database devices 302-303, which can be operatively coupled to the servers 304-306, as well as to clients 307-309, via the communications network 301. The servers 304-306, clients 307-309, and database devices 302-303 can be implemented as computing devices. Those skilled in the art will recognize that the database devices 302-303 can be incorporated into one or more of the servers 304-306 such that one or more of the servers can include databases.

In exemplary embodiments, the system 100 can be distributed among different devices, e.g., servers, clients, databases, in the communication network 301 such that one or more components of the system 100, or portions thereof, can be implemented by different devices in the communication network 301. For example, in illustrative embodiments, the central unit 120, or portions thereof, can be implemented by the server 304, the 3D scan network 140, or portions thereof, can be implemented by the server 305, and the production network 150, or portions thereof, can be implemented by the server 306. Clients 307-309 can represent the device consumer/scan subject 111, scan subject 112, device consumers 113, and the like, implementing a computing device having a web browser and/or a graphical user interface, where the clients 307-309 can use the computing devices to input the 3D scan data 128, production data 129, delivery data 130, security data 131, user data 132, and the like, into the central database 121 over the network 301 and further receive verification information and/or custom sexual stimulation device production status information over the network 301 in a format understandable to the clients 307-309. The database devices 302 and 303 can be configured to store a variety of information relevant and/or applicable to the customization of the sexual stimulation device and the production and delivery of the custom sexual stimulation device, e.g., the user, the user delivery address, and the like.

It should be noted that the exemplary embodiments of system 100 can include a variety of database devices 302-303 having various database file configurations and data file formats. The database devices 302-303 can also include, e.g., software programs, programming code and program modules. Database file configurations can be, e.g., PLY, STL, OBJ, X3D, Collada, VRML 97/2 files formats, and the like. The software programs, code or modules can be in a programming language, machine code or other format usable by a microprocessor, computer and/or computing system. Some of the database files, data files or programs can be stored on, e.g., non-volatile hard drives, or within, e.g., solid-state memory device, or the like.

As discussed herein, the database, database file, data file, program, code, program module, and the like, can be stored in a data store. A data store generally includes, e.g., single and/or multiple non-volatile memory device(s), other types of non-volatile computer readable mediums adapted to store databases, database files, data files, programs, codes or program modules, and the like. The non-volatile memory device(s) can include one or more types of non-volatile memory, including, e.g., electro-mechanical, magnetic, optical, flash, other solid state or non-solid state types of non-volatile memory, and the like. As would be understood by one of ordinary skill in the art, database file information, data file information and software do not always reside in non-volatile memory. Instead, database file information, data file information and software can also be stored temporarily during operation of the exemplary systems in various types of volatile memory. Furthermore, other types of computer readable mediums can include, without limitation, e.g., magnetic and optical computer readable mediums, flash memory, battery backed volatile memory, reasonable facsimiles or derivations thereof, and the like.

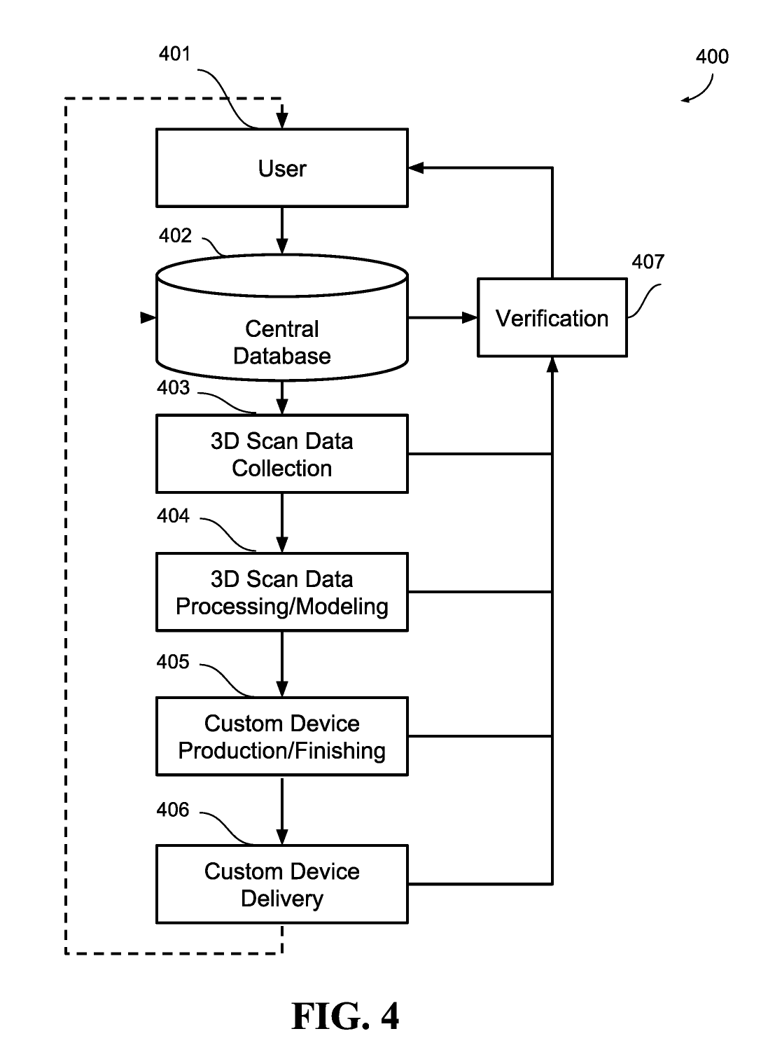

Turning now to FIG. 4, an alternative flowchart illustrating an exemplary process performed using embodiments of the custom sexual stimulation device production system 100 (400) is depicted. Specifically, a user 110 (401), e.g., a device consumer/scan subject 111, a scan subject 112, a device consumer 113, a combination thereof, and the like, can initially provide data 134 over the network 101, depicted by the arrows, to the central database 121 (401). The central database 121 (402) can then manage, organize in a standardized and/or normalized form, and/or store the 3D scan information relevant to specific networks, e.g., the 3D network 140, the production network 150, the delivery network 160, the security network 170, and the like, participating in the custom sexual stimulation device production system 400. Further, the central database 121 (402) can verify 180 (407) data 134 against these networks to confirm that the data 134 provided is acceptable for the production of of a custom sexual stimulation device (not shown). If the verification 180 (407) step is successful, the system 100 (400) can proceed as discussed below. However, if the verification 180 (407) step reveals that the 3D scan information provided previously to the central database 121 (402) is unacceptable and/or that additional information is required, the system 100 (400) can contact the user 110 (401) over the network by, e.g., a graphical user interface, email, postal service, and the like, to request the additionally required 3D scan information. The verification 180 (407) step can then repeat to confirm that the new 3D scan information provided is sufficient to proceed in the system 100 (400).

Still with reference to FIG. 4, once the 3D scan information has been verified, the central database 121 (402) can transfer data 134 to the 3D network 140 for use in remote collection, processing, and transmission of 3D scan data 128 (403). As would be apparent to those of ordinary skill in the art, the 3D scan network 140 can utilize a 3D input device distributor 144 (not shown) to deliver a 3D input device 145 (not shown) to the user 110 (401) via the delivery network 160, depicted by the dashed arrows. Thus, the 3D network 140 can remotely collect 3D scan data 128 from users 110 (401). The 3D network 140 can further proceed by transforming the remotely collected 3D scan data 128 via 3D scan data processing 142 and 3D scan data modeling 143 (404) into a form acceptable by the production network 150 for use in producing 152 and finishing 153 the custom device 155 (not shown) (405). As previously discussed above, once the custom device 155 (not shown) has been created by the production network 150, the delivery network 160, e.g., the post office, can obtain the custom device 155 and the delivery data 130 necessary for delivering the custom device 155 (not shown) to the user 110 (401) specified address and/or location (406). Further, as stated above, the verification step 180 (407) can occur prior to, during, and/or after any and/or all steps of the process discussed herein, thereby providing the user 110 (401) a convenient, private, and effective tracking system for determining the status of the production and delivery of the custom device 155 delivery throughout system 100 (400).

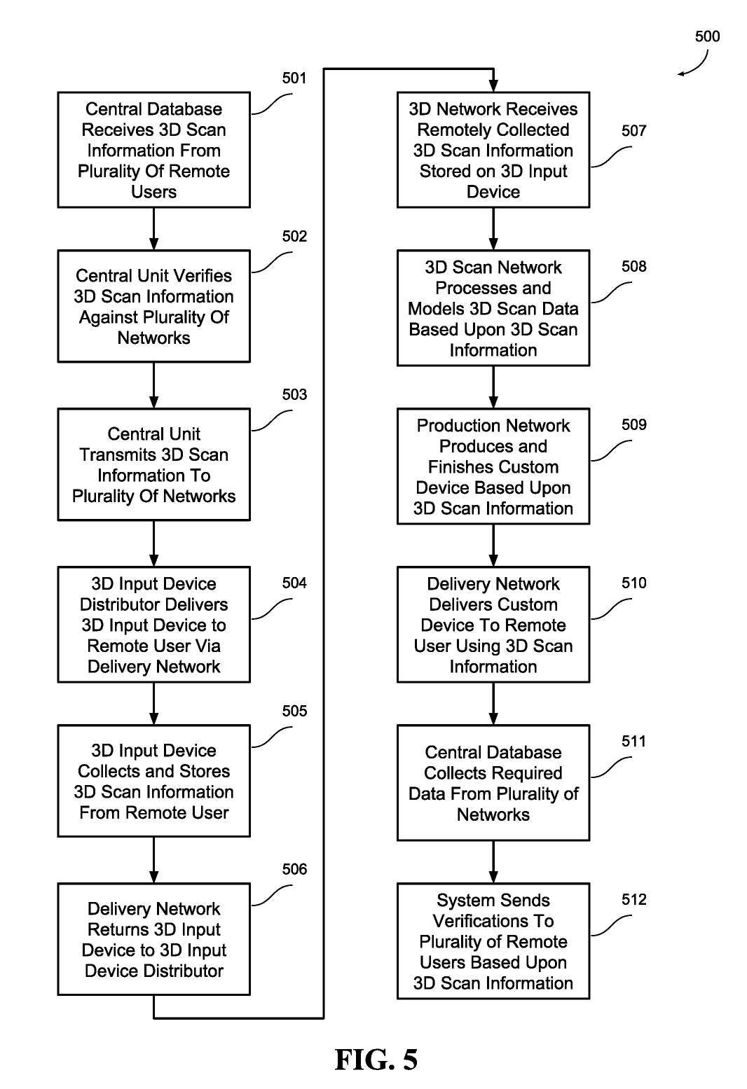

With reference now to FIG. 5, a flowchart illustrating an exemplary process performed using embodiments of the custom sexual stimulation device production system 500 is presented. It should be noted that each step of the process depicted in FIG. 5 is connected by a network 101, e.g., the internet, and 3D scan information at each step can be sent over the network 101 to any other step in the process. Initially, user 110 enters the required 3D scan information, i.e., data essential for initiation of the production of a custom sexual stimulation device, via a communication method, e.g., a browser, graphical user interface, and the like, and the required 3D scan information is provided to and stored in the central database 121 over the network 101 (501). Once the central database 121 has received the required 3D scan information, the data is verified against production requirements of all networks, e.g., the 3D network 140, the production network 150, the delivery network 160, security network 170, a combination thereof, and the like, (502). The central database 121 can then transmit the verified 3D scan information to all of the relevant networks/entities of the system 500, e.g., the 3D network 140, the production network 150, the delivery network 160, the security network 170, and the like (503).

Still with reference to FIG. 5, if the 3D scan information has been previously verified, the 3D scan network 140 then delivers a 3D input device 145, e.g., a 3D scanner, to the user 110 through a 3D input device distributor 144 via the delivery network 160 (504). Once delivered, the user 110 utilizes the 3D input device 145 to remotely collect and store 3D scan data 128 and related 3D scan information (505). Once the user 110 has remotely collected and stored 3D scan information, the 3D input device 145 is delivered back to the 3D scan network 140 through the 3D input device distributor 144 via the the delivery network 160 (506). The 3D scan network 140 then remotely collects the required 3D scan information from the 3D input device 145 (507). The user 110's 3D scan information is then transformed by the 3D network 140 through 3D scan data processing 142 and 3D scan data modeling 143 into a final acceptable data form, e.g., a 3D scan model acceptable to the elements of the production network 150 and necessary to produce a custom device 155 (508). In some exemplary embodiments, the 3D scan network 140 may collect user 110 3D scan information via a 3D input device data transmission 146 over the network 101 prior to return of the 3D input device 145 from the user 110 back to the 3D input device distributor 144 (not shown). Further, in some exemplary embodiments, the user 110 may transmit 3D scan information electronically directly to the 3D scan network 140 over the network 101 without requiring that a 3D input device 145 be deliver by the 3D network 140 (not shown).

Further still, once the 3D scan network 140 has transformed the user 110 3D scan information into a final acceptable form to the production network 150 (508), the device production 152 and a device finishing 153 elements of the production network 150 utilize the 3D scan information for custom device 155 production 152 and finishing 153 (509). The delivery network 160 then delivers the custom device 155 via an acceptable physical delivery method 162, e.g., United States Postal Service, FedEx™, and the like, to a user 110 via the delivery network 160 (510).

The system 500 can then obtain all of the relevant 3D scan information with respect to the production of a custom device 155 from the plurality of networks and/or entities involved, e.g., the 3D network 140, the production network 150, the delivery network 160, the security network 170, and the like (511). Similar to the verification step 502 discussed above, system 500 can then report the 3D scan information obtained from the plurality of networks and/or entities involved to the user 110, e.g., the customer/subject 111, the subject 112, the customer 113, and the like, via a communication method, e.g., the network 101, email, letter, and the like (512). In particular, the verification 180 communicates the 3D scan information from the plurality of networks and/or entities involved in a form and manner comprehensible to a user 110, e.g., a graphical user interface, and can occur, e.g., after the custom device 155 has been produced by the production network 150, after particular steps of the process as discussed herein, after each step of the process as discussed herein, and the like (512). Further, similar to the verification steps 502 and 512 discussed above, access restrictions 172 can occur after particular steps and/or after each step taken by the system 500. Access restrictions 172 can originate from the central unit 120, which remotely collects the applicable 3D scan information from all associated networks for each user 110 participating in the system 500, and then distributes the 3D scan information to each user 110 in order to provide a system of security and privacy in connection with the production and delivery of the custom device 155 (512). The security and privacy system, i.e., access restrictions 172, can collect and provide security data 131, e.g., passwords, identity verification, and the like via, e.g., a graphical user interface, an email, postal service, and the like, in connection with a user's 110 access the system 500 (511). However, it should be understood to those of ordinary skill in the art that access restrictions 172 can originate at, e.g., the central unit 120, each participating network of the system 500, a combination of said locations, and the like. In particular, the access restrictions 172 can obtain security data 131 from, e.g., a user 110 before, during, and/or after, e.g., the central database 121 collecting 3D scan information from users 110 (501), the 3D scan network's 140 remote collection of 3D scan information from a user 110 (505), the production network 150's transformation of 3D scan information into a custom device 155 (509), the delivery network 160 shipping a custom device 155 to a user 110 via a physical delivery method 163 using delivery data 130 (510), and the like. Thus, each user 110 is provided with a method of ensuring the security and privacy of their 3D scan information and custom device 155 throughout the system 100. Optionally, access restrictions 172 can occur in conjunction with and/or simultaneously with a verification 180 prior to, during, and/or after each particular step taken by the system 500 (512).

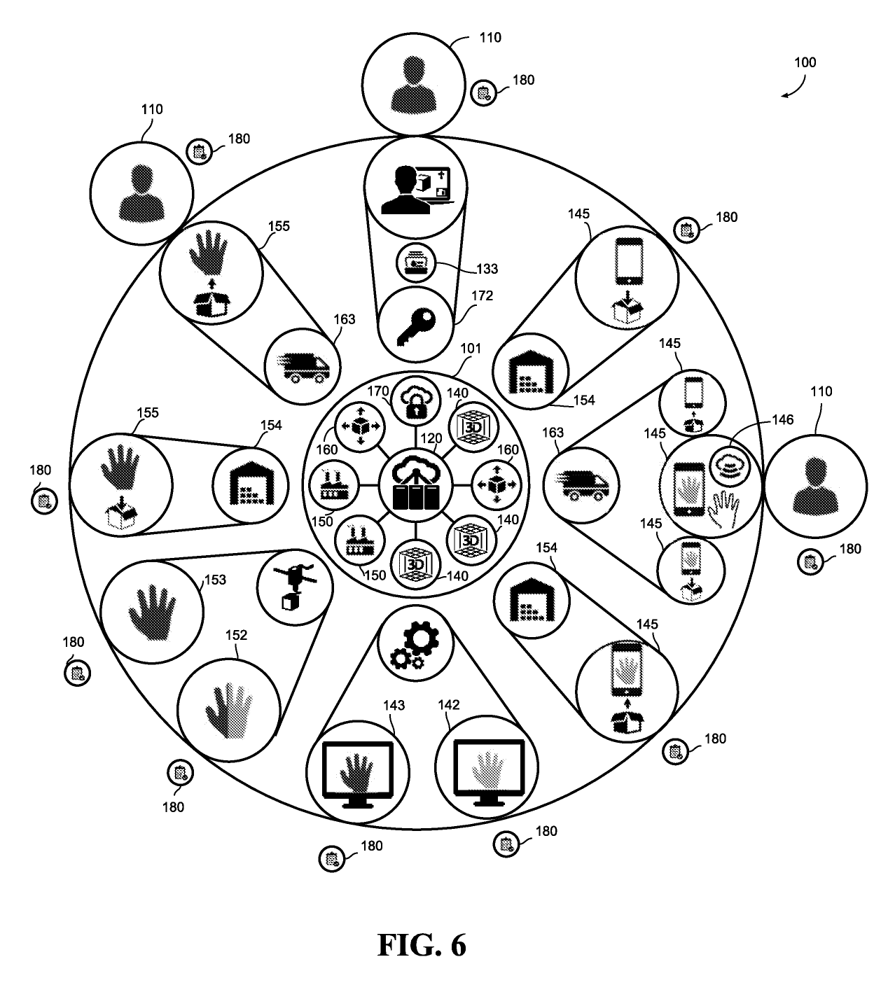

With reference now to FIG. 6, a diagram illustrating an exemplary process performed using embodiments of the sexual stimulation device production system 100 is presented. In particular, FIG. 6 depicts elements of system 100 substantially similar to those of FIG. 1, e.g., a user 110, a central unit 120, a 3D scan network 140, a production network 150, a delivery network 160, i.e., a mailing network, a security network 170, and the like. Network 101 connects the plurality of networks of the system 100 and a verification 180 is also provided. As can be seen from FIG. 6, each user 110, i.e., a device consumer/scan subject 111, a scan subject 112, a device consumer 113, and the like, can provide data 134, e.g., 3D scan data 128, production data 129, delivery data 130, security data 131, user data 132 and the like, to the 3D scan network 140, which further includes a 3D scan database 141 (not shown). The 3D scan network 140 can then, through the network 101, transfer data 134 to the central unit 120, which includes a central database 121 (not shown) for storing the 3D scan information for a plurality of users 110 participating in the system 100. In particular, each network of the system 100 can remotely collect, store (in an associated database), and distribute data 134 to other networks associated with the system 100 and/or to the central unit 120 for storage in a standardized and/or normalized form. The 3D scan data network 140 can remotely collect the required data 134 from each user 110 via a 3D input device 145 that through a 3D input device distribution 144 element via the delivery network 160. Specifically, the 3D input device distribution 144 element delivers a 3D input device 145 via a physical delivery method 163 directly to the user 110. The user 110 utilizes the 3D input device 145 to collect and store the required data 134. The 3D input device 145 is thereafter delivered back to the 3D input device distribution element 154 via a physical delivery method 163. The 3D scan database 141 (not shown) receives the data 134 via the 3D scan data network 140 and stores that data 134 for use by the plurality of networks of the system 100. Optionally, the required data 134 can be collected from the 3D input device 145 by the 3D scan database 140 over the network 101 via 3D input device data transmission 146 prior to delivery of the 3D input device 145 back to the 3D input device distribution 144 element. Optionally, the required data 134 can be electronically transferred directly from a user 110 over the network 101 to the 3D scan data network 140, thereby obviating the need for delivery of a 3D input device 145 to a user 110.

The data 134 provided by the user 110 can further be distributed by the network 101 to the 3D data processing 142 element and 3D data modeling 143 elements in preparation for the production network 150. Thus, the 3D scan network 140 can remotely collect data 134 in the 3D scan database 141, transform unprocessed 3D scan data 128 through 3D data processing 142 and 3D data modeling 143 elements, e.g., reconstruction of raw unprocessed 3D imaging data, conversion of processed that 3D scan data into a standardized 3D model format, and then transfer the processed 3D model to the production network 150, thereby converting the unprocessed 3D scan data 128 into production-ready 3D model data. By communicating with the central unit 120 over the network 101, the production network 150 can receive 3D scan information relevant to the specific custom device 155 to be produced for a user 110, e.g., the material of the custom device 155, the finish of the custom device 155, and the like, and can effectively transform the processed 3D scan data 128 into an acceptable custom device 155, e.g., a dildo, a vibrator, and the like. The production network 150 then transfers the custom device 155 to the delivery network 160 through device distribution 154 element and the delivery network 160 obtains the required 3D scan information for delivering the custom device 155 to the user 110 from the central unit 120. Thus, a physical custom device 155, e.g., a dildo, a vibrator, and the like, is delivered to the user 110, i.e., a device consumer/scan subject 111, a scan subject 112, a device consumer 113, and the like, to an address specified by the user 110.

Still with reference to FIG. 6, as previously disclosed herein, the verification 180 can occur before, during, and/or after each particular step taken by the system 100. As depicted in FIG. 6, the verification 180 can originate from the central unit 120, which remotely collects the applicable 3D scan information from all associated networks for each user 110 participating in the system 100, and then distributes the 3D scan information to each user 110 in order to provide a tracking system of production and delivery of the custom device 155. The tracking system, i.e., verification 180, can provide 3D scan information via, e.g., a graphical user interface, an email, postal service, and the like, thereby providing 3D scan information easily accessible, current, and understandable to each user 110. However, it should be understood to those of ordinary skill in the art that the verification 180 can originate at, e.g., the central unit 120, each participating network of the system 100, a combination of said locations, and the like. In particular, the verification 180 can obtain tracking data from, e.g., the delivery network 160 when a 3D input device 145 has been shipped for delivery to a user 110, the 3D scan network 140 when 3D scan data 128 has been transformed into 3D model data, the production network 150 when production data 129 has been transformed into a custom device 155 acceptable to the user 110, the delivery network 160 when it has shipped the custom sexual stimulation device 155 to the user 110 via a physical delivery method 163 using delivery data 130, and the like. Thus, the user 110 is provided with a method of tracking the user's 110 custom device 155 throughout the system 100.

As further depicted in FIG. 6, access restrictions 172 can occur after particular steps and/or after each step taken by the system 100. Access restrictions 172 can originate from the central unit 120, which remotely collects the applicable 3D scan information from all associated networks for each user 110 participating in the system 100, and then distributes the 3D scan information to each user 110 in order to provide a system of security and privacy in connection with the production and delivery of the custom device 155. The security and privacy system, i.e., access restrictions 172, can collect and provide security data 131, e.g., passwords, identity verification, and the like via, e.g., a graphical user interface, an email, postal service, and the like, in connection with a user's 110 access the system 100. However, it should be understood to those of ordinary skill in the art that access restrictions 172 can originate at, e.g., the central unit 120, each participating network of the system 100, a combination of said locations, and the like. In particular, the access restrictions 172 can obtain security data 131 from, e.g., user 110 prior to the 3D scan network's 140 remote collection of 3D scan data 128 from a user 110, a suer 110 prior the production network 150's transformation of 3D scan data 128 into a custom device 155 using a user's 110 3D scan data 128, from a user 110 prior to the delivery network 160 shipping a custom device 155 to a user 110 via a physical delivery method 163 using delivery data 130, and the like. Thus, each user 110 is provided with a method of ensuring the security and privacy of their data 134 and device 155 throughout the system 100. Optionally, access restrictions 172 can occur in conjunction with and/or simultaneously with a verification 180 prior to, during, and/or after each particular step taken by the system 100.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. All such various combinations and permutations are intended to be included herein within the scope of this disclosure and protected by the following claims.

The invention claimed is:

1. A computer-implemented method for producing custom sexual stimulation devices, the method comprising performing the operations of:
receiving, by a computer processing device, 3D scan information from at least one remote user;
providing, by the computer processing device, the 3D scan information to a database;
verifying, by the computer processing device, the 3D scan information against at least one network database to confirm an acceptability of the 3D scan information for use in production of at least one custom sexual stimulation device;
transmitting, by the computer processing device, the 3D scan information to a plurality of networks via a communications network;
transforming, by the computer processing device, the 3D scan information into forms and formats acceptable to the plurality of networks;
initiating, by the computer processing device, production of at least one custom sexual stimulation device based upon the 3D scan information;
delivering at least one custom sexual stimulation device to at least one remote user; and
providing real-time feedback to at least one remote user, by the computer processing device, regarding a status of at least one of the receiving step, the providing step, the verifying step, the transmitting step, the transforming step, the initiating step, and the delivering step.

2. The computer-implemented method of claim 1, wherein the 3D scan information is further comprised of at least one of 3D scan data, production data, delivery data, security data, user data, and verification data.

3. The computer-implemented method of claim 1, wherein the at least one remote user is further comprised of at least one remote scan subject and at least one remote device consumer, or a combination thereof.

4. The computer-implemented method of claim 1, comprising receiving, via the processing device, 3D scan information from the at least one remote user, is via at least one of a 3D input device delivered to a remote user by a physical delivery method, electronic transmission of 3D scan information by a remote user over a network, electronic transmission of 3D scan information from a 3D scan information repository over a network, or a combination thereof.

5. The computer-implemented method of claim 1, comprising providing, via the processing device, 3D scan information from the at least one remote user, is via at least one of a 3D input device delivered to a remote user by a physical delivery method, electronic transmission of 3D scan information by a remote user over a network, electronic transmission of 3D scan information from a 3D scan information repository over a network, or a combination thereof.

6. The computer-implemented method of claim 1, wherein the at least one network database is further comprised of at least one of a 3D scan database, a production database, a delivery database, and a security database.

7. The computer-implemented method of claim 1, wherein the plurality of networks includes at least one of a 3D scan data processing vendor, 3D scan data modeling vendor, a 3D printing vendor, 2 3D input device distribution vendor, a device production vendor, a device distribution vendor, a device delivery vendor, and a data security vendor.

8. The computer-implemented method of claim 1, comprising providing real-time feedback, by the computer processing device, related to at least one operation taken by the plurality of networks.

9. The computer-implemented method of claim 8, wherein the real-time feedback is at least one of 3D scan data, production data, delivery data, security data, and user data.

10. The computer-implemented method of claim 1, wherein the 3D scan information is transmitted, via the computer processing device, to the plurality of networks in a standardized form.

11. The computer-implemented method of claim 10, wherein the standardized form provides the 3D scan information to the plurality of networks in an easily accessible and understood form.

12. The computer-implemented method of claim 1, wherein the transformation of 3D scan information is further comprised of at least one of transforming unprocessed 3D scan data to processed scan data, transforming processed 3D scan data to 3D model data, transforming 3D model data into production data, and transforming production data into a custom sexual stimulation device.

13. The computer-implemented method of claim 1, wherein the operations of the receiving step, the providing step, the verifying step, the transmitting step, the transforming step, the initiating step, and the delivering step are automated.

14. A computer-implemented system for a plurality of remote users to produce custom sexual stimulation devices, the system comprising:
a computer storage device to store 3D scan information relating to each of the plurality of remote user; and
a computer processing device to (i) receive 3D scan information from the plurality of remote users; (ii) provide the 3D scan information to a database; (iii) verify the 3D scan information received from each of the plurality of remote users against at least one of network database to confirm an accuracy of the 3D scan information for production of at least one custom sexual stimulation device, (iv) transmitting the 3D scan information to the plurality of networks via a communications network, wherein the plurality of networks includes at least one one 3D scan network, one production network, one delivery network, one security network, or a combination thereof (v) initiate the production of a custom sexual stimulation device based upon the 3D scan information, (vi) deliver a custom sexual stimulation device to at least one of the plurality of remote users, and (vii) provide real-time feedback regarding a status of at least one of the receiving step, the providing step, the verifying step, the transmitting step, the transforming step, the initiation step, and the delivering step.

15. The computer-implemented system of claim 14, a graphical user interface (GUI) for providing the 3D scan information relating to each of the plurality of remote users to the computer storage device.

16. The computer-implemented system of claim 14, a graphical user interface (GUI) for receiving the 3D scan information relating to each of the plurality of remote users to the computer storage device.

17. The computer-implemented system of claim 14, wherein the processing device stores in the computer storage device information related to the production of custom sexual stimulation devices based upon the 3D scan information, and delivery of the custom sexual stimulation device to at least one of the plurality of remote users.

18. A non-transitory computer readable medium storing instructions, wherein execution of the instructions by a processing device causes the processing device to implement a computer-implemented method, the computer-implemented method comprising performing the operations of:
receiving, by a computer processing device, 3D scan information from at least one remote user;
providing, by the computer processing device, the 3D scan information to a database;
verifying, by the computer processing device, the 3D scan information against at least one network database to confirm an acceptability of the 3D scan information for use in production of at least one custom sexual stimulation device;
transmitting, by the computer processing device, the 3D scan information to a plurality of networks via a communications network;
transforming, by the computer processing device, the 3D scan information into forms and formats acceptable to the plurality of networks;
initiating, by the computer processing device, production of at least one custom sexual stimulation device based upon the 3D scan information;
delivering at least one custom sexual stimulation device to at least one remote user; and
providing real-time feedback to at least one remote user, by the computer processing device, regarding a status of at least one of: the receiving step, the providing step, the verifying step, the transmitting step, the transforming step, the initiating step, and the delivering step.
